(19) United States
(12) Patent Application Publication
(10) Pub. No.: US 2005/0279384 A1
(43) Pub. Date: Dec. 22, 2005

(54) METHOD AND PROCESSING SYSTEM FOR CONTROLLING A CHAMBER CLEANING PROCESS

(76) Inventor: Emmanuel P. Guidotti, Fishkill, NY (US)

Correspondence Address: WOOD, HERRON & EVANS, LLP (TOKYO ELECTRON), 2700 CAREW TOWER, 441 VINE STREET, CINCINNATI, OH, 45202, US

(21) Appl. No.: 10/710,086

(22) Filed: Jun. 17, 2004

(51) Int. Cl. B08B 7/04

(52) U.S. Cl. 134/18; 134/22.1; 134/19; 118/715; 156/345.1

(57) ABSTRACT

A method and system for controlling an exothermic chamber cleaning process in a process chamber. The method includes exposing a system component to a cleaning gas in the chamber cleaning process to remove a material deposit from the system component, monitoring at least one temperature-related system component parameter in the chamber cleaning process, determining the cleaning status of the system component from the monitoring, and based upon the status from the determining, performing one of the following: (a) continuing the exposing and monitoring, or (b) stopping the process.

### FIELD OF THE INVENTION

This invention relates to chamber cleaning, and more particularly, to controlling an exothermic chamber cleaning process.

### BACKGROUND OF THE INVENTION

Many semiconductor fabrication processes are performed in processing systems such as plasma etch systems, plasma deposition systems, thermal processing systems, chemical vapor deposition systems, atomic layer deposition systems, etc. Processing systems commonly use a substrate holder that supports and can provide heating of a substrate (e.g., a wafer). he substrate holder can contain ceramic materials that provide low thermal expansion, high temperature tolerance, a low dielectric constant, high thermal emissivity, a chemically “clean” surface, rigidity, and dimensional stability that makes them preferred substrate holder materials for many semiconductor applications. Common ceramic materials for use in ceramic substrate holders include alumina (Al₂O₃), aluminum nitride (AlN), silicon carbide (SiC), beryllium oxide (BeO), and lanthanum boride (LaB₆).

Processing of substrates in a processing system can result in formation of a material deposit on a substrate holder and other system components in the process chamber that are exposed to the process environment. Periodic chamber cleaning is carried out to remove the material deposits from the process chamber. System components are commonly replaced or cleaned after material deposits threaten particle problems, in between incompatible processes to be run in sequence, after detrimental processing conditions, or after poor processing results are observed. A dry cleaning process can be carried out using an approach where the length of the cleaning process is based on a fixed time period that has been proven to result in adequate cleaning of the system components. However, because the cleaning process is not actually monitored, the fixed time period may be unnecessarily long and result in undesired etching (erosion) of the system components.

### SUMMARY OF INVENTION

A method and system is provided for controlling an exothermic chamber cleaning process in a process chamber. The method includes exposing a system component to a cleaning gas in the chamber cleaning process to remove a material deposit from the system component; monitoring at least one temperature-related system component parameter in the chamber cleaning process, where the temperature-related parameter may be one or more of the system component temperature, the heating power level, or the cooling power level; determining the cleaning status of the system component from the monitoring of the temperature-related parameter(s); and based upon the determined status, performing one of the following: (a) continuing the exposing and monitoring, or (b) stopping the process.

The processing system includes a process chamber having a system component containing a material deposit, a gas injection system configured for exposing the system component in the process chamber to a cleaning gas in a chamber cleaning process to remove a material deposit from the system component, and a controller configured for monitoring the at least one temperature-related system component parameter in the chamber cleaning process, to determine the cleaning status of the system component. The controller is further configured for controlling the processing system in response to the status.

The processing system can further contain a power source configured for applying heating power to the system component and a heat exchange system configured for applying cooling power to the system component. The system component can include a substrate holder, a showerhead, a shield, a ring, a baffle, an electrode, or a chamber wall.

### BRIEF DESCRIPTION OF DRAWINGS

In the accompanying drawings:

FIG. 1 shows a schematic diagram of a processing system in accordance with an embodiment of the invention;

FIG. 2 shows a schematic diagram of a processing system in accordance with another embodiment of the invention;

FIGS. 3A and 3B show schematic cross-sectional views of a substrate holder in accordance with an embodiment of the invention;

FIG. 4A is a graph schematically showing system component parameters as a function of time in a chamber cleaning process in accordance with an embodiment of the invention;

FIG. 4B is a graph schematically showing an adjusted system component parameter as a function of time in a chamber cleaning process in accordance with an embodiment of the invention;

FIG. 5 is a graph showing substrate holder parameters as a function of time in a chamber cleaning process in accordance with an embodiment of the invention;

FIG. 6 is a graph schematically showing system component parameters as a function of time in a chamber cleaning process in accordance with an embodiment of the invention;

FIG. 7 is a flowchart showing a method of monitoring cleaning status of a system component in a chamber cleaning process according to an embodiment of the invention;

FIG. 8 is a flowchart showing a method of monitoring cleaning status of a system component in a chamber cleaning process according to an embodiment of the invention; and

FIG. 9 is a depiction of a general purpose computer which may be used to implement the present invention.

### DETAILED DESCRIPTION

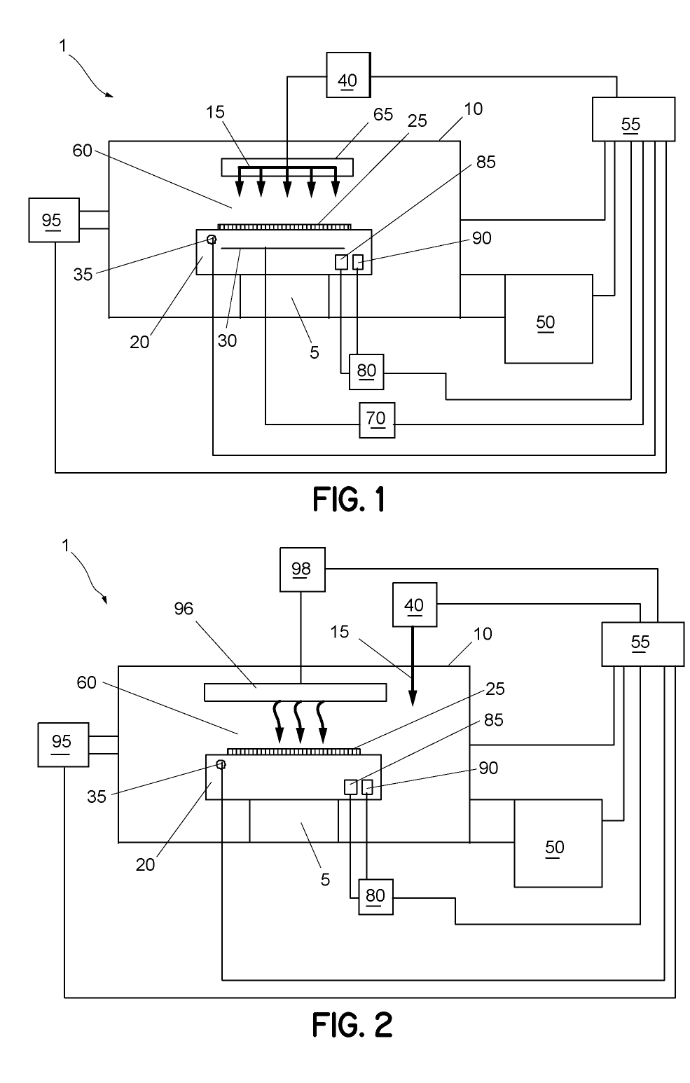

FIG. 1A shows a schematic diagram of a processing system in accordance with an embodiment of the invention. The processing system 1 includes a process chamber 10 having a pedestal 5 for mounting a substrate holder 20 for supporting and controlling the temperature of a substrate 25, a gas injection system 40 for introducing a process gas 15 to the process chamber 10, and a vacuum pumping system 50. The process gas 15 can, for example, be a cleaning gas for performing a cleaning process in the process chamber 10 (including removing a material deposit from substrate holder 20 and other system components in the process chamber 10), or a gas for processing the substrate 25. The gas injection system 40 allows independent control over the delivery of process gas 15 to the process chamber 10 from ex-situ gas sources (not shown). Gases can be introduced into the process chamber 10 via the gas injection system 40 and the chamber pressure adjusted. Controller 55 is used to control the vacuum pumping system 50 and gas injection system 40. The gas injection system 40 can further contain a remote plasma source (not shown) for exciting a gas.

Substrate 25 can be transferred into and out of chamber 10 through a slot valve (not shown) and chamber feed-through (not shown) via a robotic substrate transfer system 95, where it is received by substrate lift pins (not shown) housed within substrate holder 20 and mechanically translated by devices housed therein. Once the substrate 25 is received from the substrate transfer system, it is lowered to an upper surface of the substrate holder 20. In one configuration, the substrate 25 can be affixed to the substrate holder 20 via an electrostatic clamp (not shown).

The substrate holder 20 contains a heating element 30 for heating the substrate holder 20 and the substrate 25 overlying the substrate holder 20. The heating element 30 can, for example, be a resistive heating element that is powered by applying heating power (AC or DC) from the power source 70. The substrate holder 20 further contains a thermocouple 35 for measuring and monitoring the substrate holder temperature. Alternatively, the substrate holder temperature may be measured using a pyrometer.

The processing system 1 in FIG. 1 further includes means for cooling the substrate holder 20 by applying cooling power to substrate holder 20. This can be accomplished by re-circulating a coolant fluid from heat exchange system 80 to substrate holder inlet 85, and from substrate holder outlet 90 back to the heat exchange system 80. Moreover, a gas (e.g., helium, He) may be delivered to the backside of the substrate 25 to improve the gas-gap thermal conductance between the substrate 25 and the substrate holder 20.

Continuing reference to FIG. 1, process gas 15 is introduced to the processing region 60 from the gas injection system 40. The process gas 15 can be introduced to the processing region 60 through a gas injection plenum (not shown), a series of baffle plates (not shown) and a multi-orifice showerhead gas injection plate 65. Vacuum pump system 50 can include a turbo-molecular vacuum pump (TMP) capable of a pumping speed up to 5,000 liters per second (and greater), and a gate valve for throttling the chamber pressure.

The controller 55 includes a microprocessor, a memory, and a digital I/O port capable of generating control voltages sufficient to communicate and activate inputs to the processing system 1 as well as monitor outputs from the processing system 1. Moreover, the controller 55 is coupled to and exchanges information with the process chamber 10, gas injection system 40, heat exchange system 80, power source 70, thermocouple 35, substrate transfer system 95, and vacuum pump system 50. For example, a program stored in the memory can be utilized to control the aforementioned components of a processing system 1 according to a stored process recipe. One example of controller 55 is a digital signal processor (DSP); model number TMS320, available from Texas Instruments, Dallas, Tex.

FIG. 2 shows a schematic diagram of a processing system in accordance with another embodiment of the invention. In the embodiment shown in FIG. 2, a process gas 15 is introduced to the processing region 60 from the gas injection system 40, and the process chamber 10 contains a lamp heater 96 for radiatively heating the substrate holder 20 and the substrate 25. The lamp heater is powered by power source 98 that is controlled by controller 55.

In FIGS. 1 and 2, the controller 55 is configured for controlling and monitoring various temperature-related system component parameters. These temperature-related parameters are all related to maintaining a system component at a desired temperature as the component is subjected to exothermic heat generated by the cleaning process. In the case of a substrate holder, the system component parameters can, for example, include substrate holder temperature measured by thermocouple 35, heating power applied to the substrate holder 20 from power sources 70 or 98, and/or cooling power applied to the substrate holder 20 from the heat exchange system 80. The controller 55 can be configured to monitor the level of heating power (e.g., current, voltage) applied to the heating element 30 or to the lamp heater 96. Furthermore, the controller 55 can be configured to monitor the power characteristics, for example voltage amplitude and phase. In addition, the controller 55 can be configured to monitor the cooling power by measuring the coolant fluid flow from the heat exchange system 80 to the substrate holder 20 or the temperature difference between the coolant fluid entering the substrate holder inlet 85 and the coolant fluid exiting the substrate holder outlet 90.

In one embodiment of the invention, the substrate 25 may be present on the substrate holder 20 in a chamber cleaning process performed in the process chamber 10. In another embodiment of the invention, a chamber cleaning process may be performed without the substrate 25 present on the substrate holder 20.

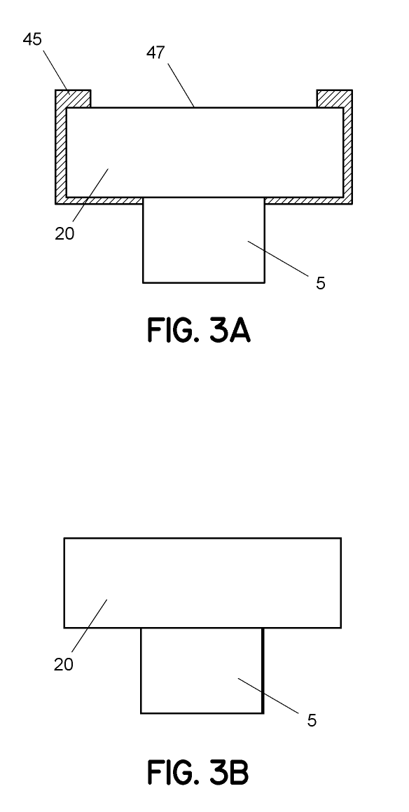

FIGS. 3A and 3B show schematic cross-sectional views of a substrate holder in accordance with an embodiment of the invention. The substrate holder 20 is supported by pedestal 5. The substrate holder 20 can contain a ceramic material, for example Al₂O₃, AlN, SiC, BeO, and LaB₆. FIG. 3A shows a material deposit 45 partially covering the substrate holder 20. The material deposit 45 in FIG. 3A can be formed on the substrate holder 20 in a manufacturing process performed on a substrate supported by the substrate holder 20, where the manufacturing process can, for example, include a deposition process performed in a deposition system where a material is deposited onto a substrate, or an etch process performed in an etch system where a material is removed from a substrate. Furthermore, substrate holder surface 47 that supports a substrate, is shielded from the process environment during processing of a substrate and can be substantially free of the material deposit 45.

The material deposit 45 may contain a single layer or, alternately, it may contain multiple layers. The thickness of the material deposit 45 can be from a few angstroms (Å) thick to several hundred angstroms thick, or thicker, and can contain one or more type of materials, for example silicon-containing materials such as silicon (Si), silicon germanium (SiGe), silicon nitride (SiN), silicon dioxide (SiO₂), or doped Si; dielectric materials including high-k metal oxides such as HfO₂, HfSiOₓ, ZrO₂, or ZrSiOₓ; metals such as Ta, Cu, or Ru; metal oxides such as Ta₂O₅, CuOₓ, or RuO₂; or metal nitrides such as Ti or TaN.

FIG. 3B schematically shows a cross-sectional view of a clean substrate holder in accordance with an embodiment of the invention. The clean substrate holder 20 is free, or substantially free, of the material deposit 45, as a result of a chamber cleaning process, where the material deposit 45 schematically shown in FIG. 3A has been removed from the substrate holder 20 by exposing the substrate holder 20 to a cleaning gas.

As persons skilled in the art of chamber processing will appreciate, embodiments of the invention are not limited to a system component such as a substrate holder, as other system components in a processing system can be used, for example a showerhead, a shield, a baffle, a ring, an electrode, and a process chamber wall.

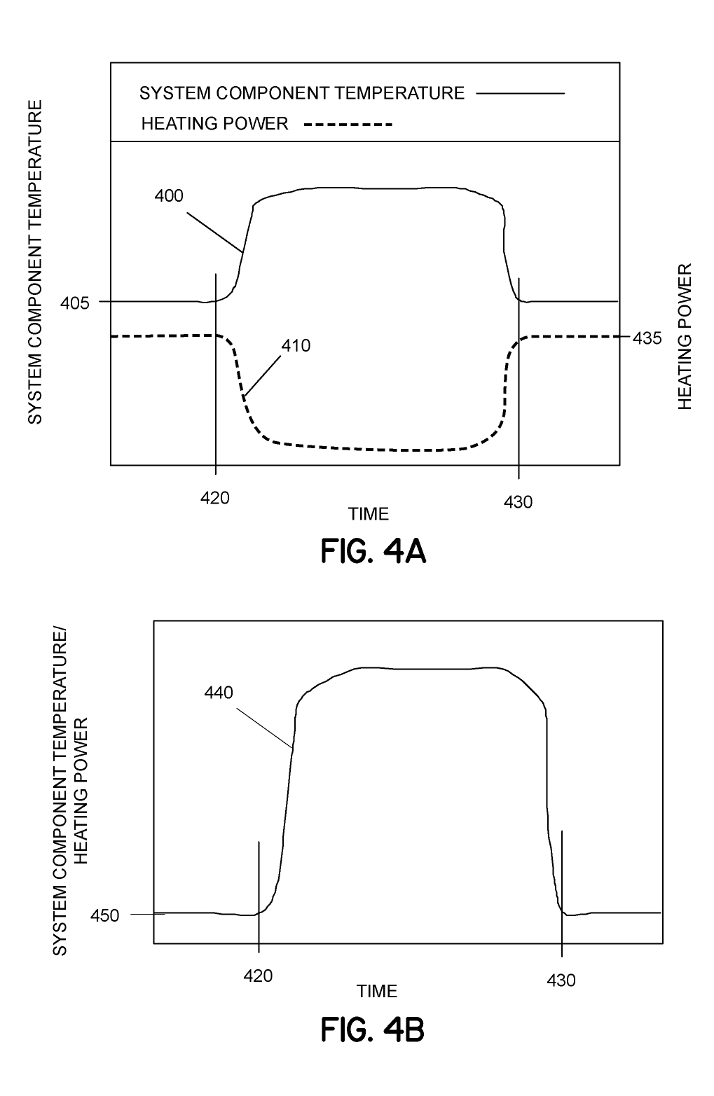

FIG. 4A is a graph schematically showing temperature-related system component parameters as a function of time in a chamber cleaning process in accordance with an embodiment of the invention. The chamber cleaning process may be performed in the exemplary processing systems shown in FIGS. 1 and 2. The system component parameters shown in FIG. 4A are system component temperature and the heating power applied to the system component. The chamber cleaning process depicted in FIG. 4A, can be an exothermic cleaning process that is performed by exposing a system component containing a material deposit to a cleaning gas for reacting with and removing the material deposit from the system component. At time 420, a cleaning gas is exposed to the system component that is held at a preselected temperature 405 using heating power level 435. The cleaning gas can, for example, include a halogen-containing gas such as ClF₃, F₂, NF₃, and HF, and the cleaning gas may further contain an inert gas selected from at least one of Ar, He, Ne, Kr, Xe, and N₂. In the cleaning process depicted in FIG. 4A, the exothermic reaction between a material deposit on the system component and the cleaning gas increases the system component temperature 400 to above the preselected temperature 405. Since the system component temperature increases above the preselected temperature 405, the controller is configured to reduce the heating power 410 applied to the system component. In the exemplary embodiment illustrated in FIG. 4A, reducing the heating power 410 is not sufficient to maintain the system component temperature at the preselected temperature 405.

The cleaning status of a system component can indicate the relative amount of a material deposit remaining on the system component surface during a chamber cleaning process. The material deposit is removed from the system component during the chamber cleaning process, and when the material deposit has been substantially removed from the system component, the system component temperature 400 in FIG. 4A decreases due to reduced heating of the system component from the exothermic cleaning process. In response to the decreasing system component temperature 400, the controller is configured to increase the heating power 410 applied to the system component, in order to prevent the system component temperature from falling below the preselected temperature 405.

Thus, as schematically shown in FIG. 4A, the system component temperature 400, the heating power 410, or both, may be used to determine a cleaning endpoint at time 430. The cleaning endpoint 430 is indicated where the system component temperature 400 and the heating power 410 approach or reach the preselected temperature 405 and heating power level 435, respectively. In general, a threshold intensity of a system component parameter (e.g., the system component temperature 400 or heating power 410) that signals a cleaning endpoint can, for example, be a preselected system component parameter intensity value (e.g., temperature 405 or power level 435), or a mathematical operation may be applied to link at least two system component parameters to create an adjusted system component parameter in order to aid in the determination of a cleaning endpoint. Exemplary mathematical operations include algebraic operations, such as division, multiplication, addition, or subtraction.

FIG. 4B is a graph schematically showing an adjusted temperature-related system component parameter as a function of time in a chamber cleaning process in accordance with an embodiment of the invention. The adjusted system component parameter curve 440 in FIG. 4B is calculated by dividing the system component temperature curve 400 by the heating power curve 410 in FIG. 4A. The cleaning endpoint 430 is indicated where the adjusted system component parameter curve 400 approaches or reaches the preselected threshold value 450, which may be calculated, for example, by dividing the preselected temperature 405 by the heating power level 435 in FIG. 4A.

In FIGS. 4A and 4B, the exemplary cleaning endpoint 430 can, for example, indicate when the system component is known to be at an acceptable clean level for a desired cleaning process. It is to be understood, that an acceptable clean level may vary depending on the production process performed in the process chamber. An acceptable clean level can, for example, be determined by correlating curve 400, curve 410, or curve 440, with other methods for determining an acceptable clean level, including spectroscopic methods and visual inspection. A cleaning process may need to be run longer if the removal of a material deposit from the system component is faster than from other system components in the process chamber. While the curves 400 and 410 in FIG. 4A show a substantial symmetry in signal intensity, it is to be understood that the curves 400 and 410 depend on the characteristics of the cleaning process and the processing system, and may be non-symmetrical. In general, The exact shapes of the curves 400 and 410 can depend on the amount, type, thickness, partial surface coverage of the material deposit, and the characteristics of the cleaning process. Furthermore, the curves 400 and 410 can depend on power requirements and response times of a system component heater, and other characteristics of the processing system.

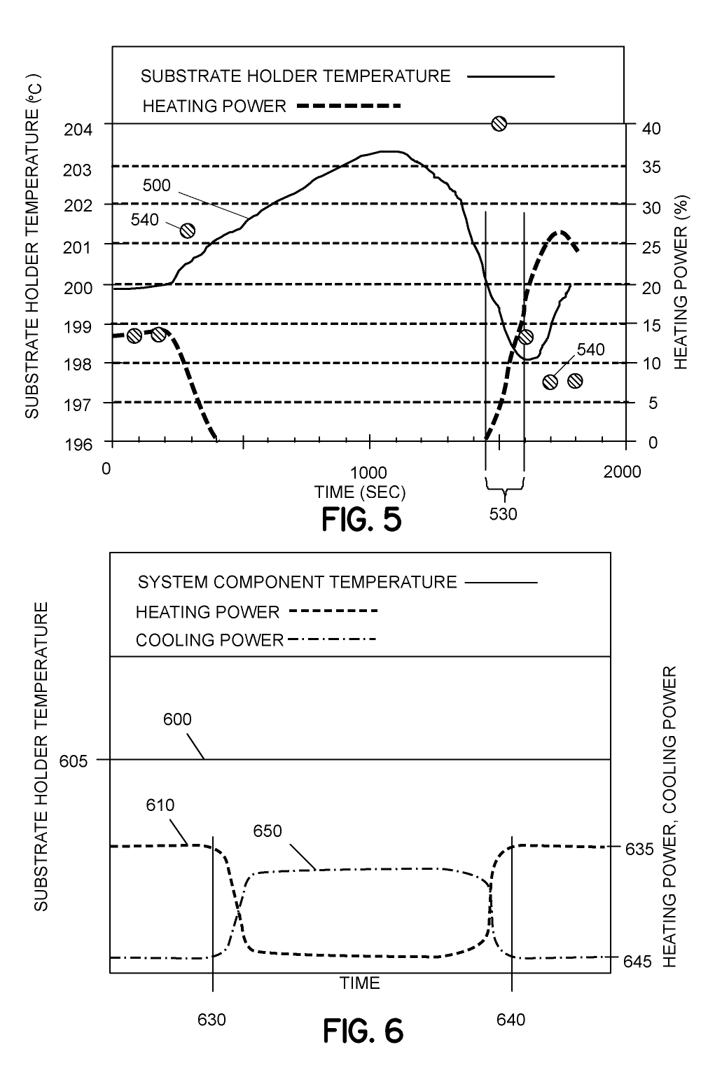

FIG. 5 is a graph showing temperature-related substrate holder parameters as a function of time during a chamber cleaning process in accordance with an embodiment of the invention. The substrate holder parameters shown in FIG. 5 are substrate holder temperature 500 and heating power 510 applied to the substrate holder. In the exothermic cleaning process shown in FIG. 5, nitrogen trifluoride (NF₃) cleaning gas was excited by a remote plasma source and flowed into a process chamber to remove a tungsten (W) metal deposit from the substrate holder and from other system components in the process chamber. At a time of about 100 sec, the NF₃ cleaning gas was flowed into the process chamber where the substrate holder was resistively heated to about 200° C., as shown by curve 500.

The cleaning process shown in FIG. 5 was sufficiently exothermic to raise the substrate holder temperature 500 to above the preselected temperature of about 200° C., and therefore, the controller decreased the amount of heating power 510 applied to the substrate holder. As seen in FIG. 5, the heating power 510 was reduced from about 14% of maximum available power at a time of about 100 sec, to about 0% at a time of about 400 sec. In the cleaning process, the substrate holder temperature 500 reached a maximum of about 203° C. at a time of about 1100 sec. After a time of about 1100 sec, the substrate holder temperature 500 started to decrease, and as it approached the preselected temperature of 200° C., the controller increased the heating power 510 in order to keep the substrate holder temperature 500 at about 200° C. As seen in FIG. 5, the substrate holder temperature 500 undershot the preselected temperature of 200° C. by about 2° C., due in part to a relatively long time constant for resistively heating the substrate holder. A cleaning process endpoint 530 was observed at a time between about 1,450 sec and about 1,600 sec, as determined from the heating power 510 and the substrate holder temperature 500. The cleaning endpoint 530 is indicated where the substrate holder temperature 500 and the heating power 510 approach or reach the preselected temperature of 200° C. and heating power level of about 14%, respectively. FIG. 5 also shows adjusted temperature-related substrate holder parameter 540, calculated by dividing the substrate holder temperature 500 by the heating power 510. The adjusted substrate holder parameter 540 was calculated every 100 sec. It can be seen that the adjusted value at the start of the process, i.e., the value at 100 sec, was reached again at about 1600 sec, thereby signaling the end of the exothermic cleaning process. Thus, essentially the same endpoint 530 was signaled with the adjusted parameter as with the separate preselected parameters.

As described above for FIG. 4A, an acceptable clean level may vary depending on the production process performed in the process chamber, and an acceptable clean level can, for example, be determined by correlating curves 500, 510, or both, or a mathematical function may be performed on the curves 500 and 510 to calculate an adjusted system component parameter 540 to determine a cleaning endpoint.

FIG. 6 is a graph schematically showing temperature-related system component parameters as a function of time during a chamber cleaning process in accordance with an embodiment of the invention. In the embodiment illustrated in FIG. 6, a system component is held at preselected temperature 605 by applying heating power level 635 and cooling power level 645 to the system component. At time 630, an exothermic cleaning process is started by exposing the system component to a cleaning gas. Subsequently, heating power 610 is reduced and cooling power 650 is increased in order to maintain the system component temperature 600 at the preselected temperature 605. When, an endpoint of the chamber cleaning process is approached at time 640, the heating power 610 is increased and cooling power 650 is decreased in order to maintain the system component temperature 600 at the preselected temperature 405. The return of the heating power 610 and/or the cooling power 650 to the initial heating power level 635 and cooling power level 645, respectively, signal the end of the exothermic cleaning process.

Thus, the embodiment of the invention shown in FIG. 6, allows for applying heating and cooling power to the system component in order to maintain the system component temperature 600 at a preselected temperature 605 during a chamber cleaning process, and provides a method for determining cleaning status of the system component and determining an endpoint of the chamber cleaning process. In FIG. 6, the heating power 610, the cooling power 650, or both, may be used to determine a cleaning endpoint at time 640. Furthermore, the mathematical function described above may, for example, be performed on the two different system component parameters (i.e., heating power and cooling power) to calculate an adjusted system component parameter to determine a cleaning endpoint.

In addition to the above-mentioned system components, other system components may be designed, manufactured, and installed in a process chamber expressly for monitoring a chamber cleaning process. Analogous to the substrate holder 20 in FIGS. 1 and 2, heating power and cooling power can be applied to the auxiliary system component and its temperature monitored, for example, by using a thermocouple. The system component can be manufactured to have a fast temperature response time to allow for better endpoint detection. A fast response time can be accomplished by manufacturing the system component utilizing materials with high thermal conductance, and selecting a system component temperature that allows for good endpoint detection.

Furthermore, as persons skilled in the art of chamber processing will appreciate, embodiments of the invention can be carried out using a system component containing means for monitoring the temperature of the system component, and optionally containing means for heating or cooling the system component. In one example, a chamber cleaning process can be controlled by monitoring the temperature of a showerhead containing a thermocouple during exposure of the showerhead to a cleaning gas.

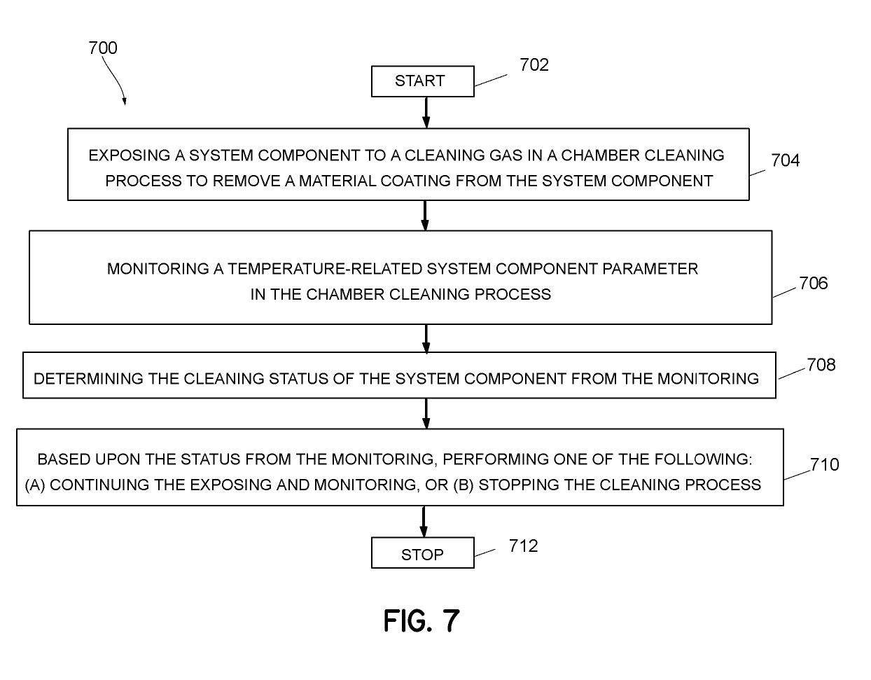

FIG. 7 is a flowchart showing a method of controlling cleaning status of a system component in a chamber cleaning process according to an embodiment of the invention. The process 700 starts at 702. At 704, the system component is exposed to a cleaning gas in the chamber cleaning process to remove the material deposit from the system component. At 706, at least one temperature-related system component parameter is monitored in the chamber cleaning process, wherein the temperature-related system component parameter includes the system component temperature, the heating power applied to the system component, or the cooling power applied to the system component. At 708, the cleaning status of the system component is determined from the monitoring. At 710, based upon the status from the monitoring, one of the following is performed: (a) continuing the exposing and monitoring, or (b) stopping the process at 712.

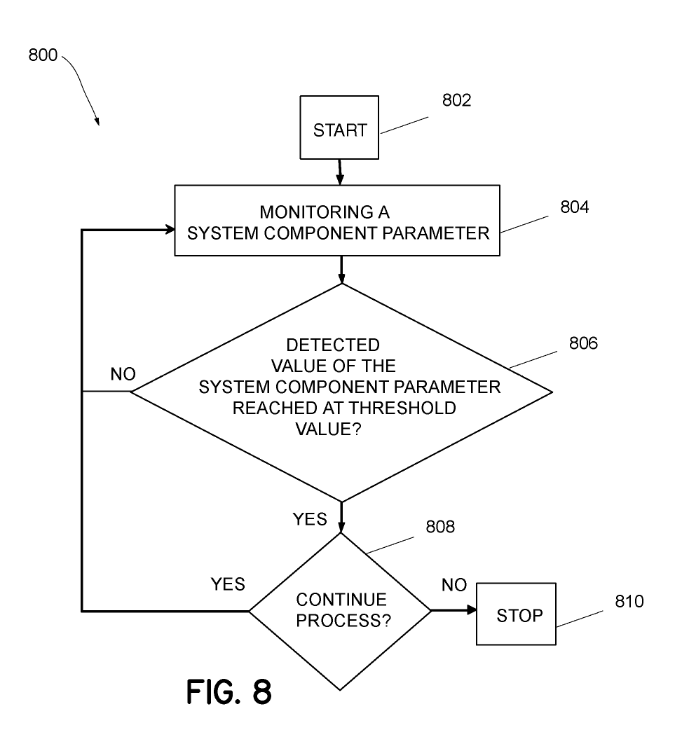

FIG. 8 is a flowchart showing a method of controlling cleaning status of a system component in a chamber cleaning process according to an embodiment of the invention. The process 800 starts at 802. At 804, a system component parameter is monitored in a chamber cleaning process. At 806, if the detected value of the temperature-related system component parameter (e.g., system component temperature, heating power, or cooling power), has not reached a threshold value, the monitoring is continued. If a threshold value has been reached at 806, indicating that removal of the material deposit is complete, or nearing completion, a decision is made at 808 whether to continue the cleaning process and the monitoring, or to stop the cleaning process at 810.

Determining whether the process should be continued in 808 can depend on the production process to be performed in the chamber. Correlation of the system component parameter to an endpoint of a cleaning process can be carried out by a test process that is performed while monitoring the at least one system component parameter and the cleaning status of a system component. Cleaning status of a system component can, for example, be evaluated by inspecting the system component during the test process and correlating the inspected results to a detected threshold intensity recorded when a desired end-point of the cleaning process is observed. The threshold intensity may, for example, be a fixed system component parameter intensity value, or a mathematical operation applied to at least two system component parameters to create an adjusted system component parameter as described in FIGS. 4B and 5.

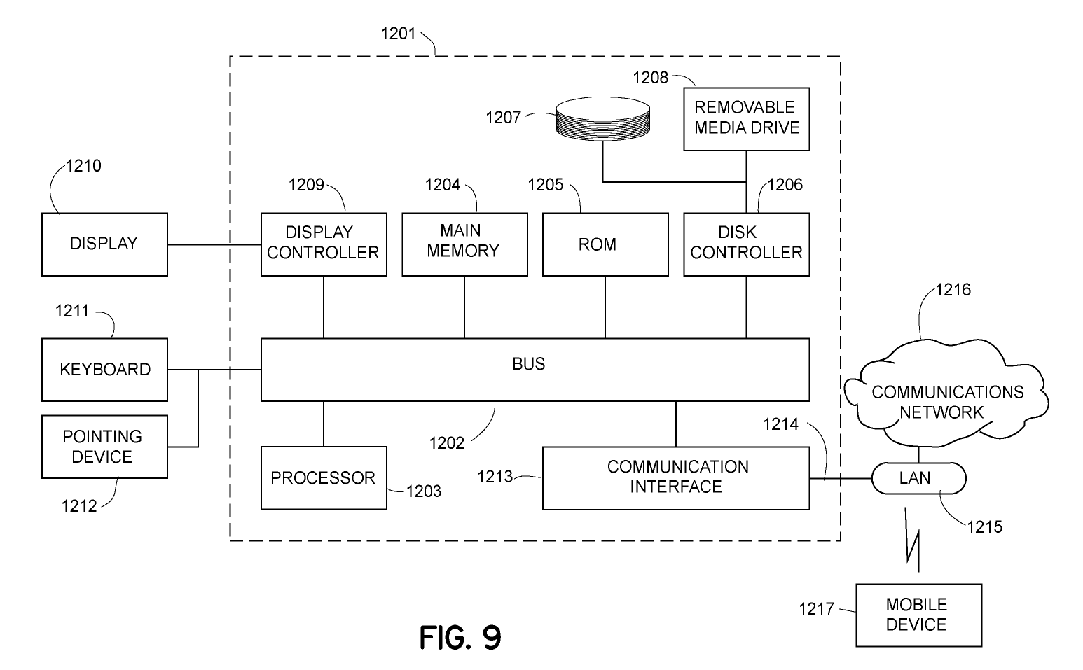

FIG. 9 illustrates a computer system 1201 upon which an embodiment of the present invention may be implemented. The computer system 1201 may be used as the controller 55 of FIGS. 1 and 2, or a similar controller that may be used to perform any or all of the functions described above. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)). The computer system may also include one or more digital signal processors (DSPs) such as the TMS320 series of chips from Texas Instruments, the DSP56000, DSP56100, DSP56300, DSP56600, and DSP96000 series of chips from Motorola, the DSP1600 and DSP3200 series from Lucent Technologies or the ADSP2100 and ADSP21000 series from Analog Devices. Other processors especially designed to process analog signals that have been converted to the digital domain may also be used. The computer system may also include one or more digital signal processors (DSPs) such as the TMS320 series of chips from Texas Instruments, the DSP56000, DSP56100, DSP56300, DSP56600, and DSP96000 series of chips from Motorola, the DSP1600 and DSP3200 series from Lucent Technologies or the ADSP2100 and ADSP21000 series from Analog Devices. Other processors specially designed to process analog signals that have been converted to the digital domain may also be used.

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a preselected frequency band, different than baseband, by modulating a carrier wave. The computer system 1201 can transmit and receive data, including program code, through the network(s) 1215 and 1216, the network link 1214, and the communication interface 1213. Moreover, the network link 1214 may provide a connection through a LAN 1215 to a mobile device 1217 such as a personal digital assistant (PDA) laptop computer, or cellular telephone.

The computer system 1201 may be configured to perform the method of the present invention for controlling a chamber cleaning process by monitoring a system component parameter in the chamber cleaning process. In accordance with the present invention, the computer system 1201 may be configured to monitor the system component parameter in a chamber cleaning process, determine the cleaning status of the system component from the monitoring, and control the chamber cleaning process in response to the determining.

Obviously, numerous modifications and variations of the present invention are possible in light of the above teachings. It is therefore to be understood that within the scope of the appended claims, the invention may be practiced otherwise that is specifically described herein.

1. A method of controlling an exothermic chamber cleaning process, the method comprising:
exposing a system component to a cleaning gas in the exothermic chamber cleaning process to remove a material deposit from the system component;
monitoring at least one temperature-related system component parameter in the chamber cleaning process;
determining the cleaning status of the system component from the monitoring; and
based upon the status from the determining, performing one of the following: (a) continuing the exposing and monitoring, or (b) stopping the chamber cleaning process.

2. The method according to claim 1, wherein the monitoring comprises monitoring the temperature of the system component.

3. The method according to claim 1, further comprising applying heating power, or cooling power, or both, to the system component, and wherein the monitoring comprises monitoring the heating power, or the cooling power, or both.

4. The method according to claim 3, wherein the applying heating power comprises powering a resistive heater or a lamp heater.

5. The method according to claim 3, wherein the applying cooling power comprises contacting the system component with a coolant fluid.

6. The method according to claim 1, wherein exposing comprises exposing the system component to a cleaning gas containing ClF₃, F₂, NF₃, or HF, or a combination of at least two thereof.

7. The method according to claim 6, wherein the cleaning gas further comprises an inert gas containing Ar, He, Ne, Kr, Xe, or N₂, or a combination of at least two thereof.

8. The method according to claim 1, wherein the monitoring comprises detecting changes in the at least one temperature-related system component parameter.

9. The method according to claim 1, wherein the determining comprises comparing the at least one temperature-related system component parameter to a threshold value.

10. The method according to claim 9, wherein the threshold value comprises a preselected system component parameter value.

11. The method according to claim 9, wherein the threshold value comprises a preselected system component temperature value.

12. The method according to claim 3, wherein the determining comprises comparing the monitored heating power, or the monitored cooling power, or both, to a threshold value.

13. The method according to claim 12, wherein the threshold value comprises heating power, or cooling power, or both, that is applied to the system component, prior to exposing the system component to the cleaning gas, in order to maintain a preselected system component temperature.

14. The method according to claim 1, wherein the performing (b) comprises stopping the chamber cleaning process after a threshold value has been reached.

15. The method according to claim 1, wherein the monitoring further comprises calculating an adjusted system component parameter by linking monitored values for two or more temperature-related system component parameters and comparing the adjusted system component parameter to an adjusted threshold value calculated by linking preselected values for the two or more temperature-related system component parameters.

16. The method according to claim 1, wherein the system component comprises a substrate holder, a showerhead, a shield, a baffle, a ring, an electrode, or a chamber wall.

17. A method of controlling an exothermic chamber cleaning process, the method comprising:
applying heating power at a preselected level to a substrate holder having a material deposit thereon to achieve a preselected substrate holder temperature;
exposing the substrate holder at the preselected substrate holder temperature to a cleaning gas in the chamber cleaning process to produce a reaction between the cleaning gas and the material deposit on the substrate holder to thereby remove the material deposit, wherein heat is generated during the reaction which increases the temperature of the substrate holder to above the preselected substrate holder temperature;
adjusting the heating power to compensate for the heat generated during the reaction;
monitoring at least one of the temperature of the substrate holder during the chamber cleaning process, or the heating power;
determining the cleaning status of the substrate holder from the monitoring by comparing at least one of the monitored temperature of the substrate holder to the preselected substrate holder temperature or the monitored heating power to the preselected level of the heating power; and
based upon the status from the determining, performing one of the following: (a) continuing the exposing and monitoring, or (b) stopping the process.

18. The method according to claim 17, wherein the monitoring comprises monitoring both the heating power and the temperature of the substrate holder.

19. The method according to claim 18, wherein stopping the process is performed when the determining indicates that the monitored heating power is equal to the preselected level of the heating power.

20. The method according to claim 17, further comprising:
applying cooling power at a preselected level to the substrate holder to achieve the preselected substrate holder temperature;
adjusting the cooling power to compensate for the heat generated during the reaction; and
monitoring the cooling power during the chamber cleaning process;
wherein the determining includes comparing the monitored cooling power to the preselected level of the cooling power.

21. The method according to claim 20, wherein stopping the process is performed when the determining indicates that the monitored cooling power is equal to the preselected level of the cooling power.

22. A computer readable medium containing program instructions for execution on a processor, which when executed by the processor, cause a processing system to perform the steps of claim 1.

23. The processing system having a process chamber, comprising:
a system component having a material deposit thereon;
a gas injection system configured for exposing the system component in the process chamber to a cleaning gas in an exothermic chamber cleaning process to remove a material deposit from the system component;
a controller configured for monitoring at least one temperature-related system component parameter in the chamber cleaning process to determine the cleaning status of the system component, and wherein the controller is further configured for controlling the processing system in response to the status.

24. The processing system according to claim 23, further comprising a power source configured for applying heating power at a preselected value to the system component and adjusting the heating power during the chamber cleaning process, wherein the controller is configured to monitor the adjusted heating power.

25. The processing system according to claim 24, wherein the power source is configured for powering a resistive heater or a lamp heater.

26. The processing system according to claim 24, further comprising a heat exchange system configured for applying cooling power at a preselected value to the system component and adjusting the cooling power during the chamber cleaning process, wherein the controller is configured to monitor the adjusted cooling power.

27. The processing system according to claim 23, further comprising a heat exchange system configured for applying cooling power at a preselected value to the system component and adjusting the cooling power during the chamber cleaning process, wherein the controller is configured to monitor the adjusted cooling power.

28. The processing system according to claim 23, wherein the gas injection system is configured for exposing the system component to a cleaning gas containing ClF₃, F₂, NF₃, or HF, or a combination of at least two thereof.

29. The processing system according to claim 28, wherein the gas injection system is further configured for exposing the system component to a cleaning gas including an inert gas containing Ar, He, Ne, Kr, Xe, or N₂, or a combination of at least two thereof.

30. The processing system according to claim 23, wherein the controller is configured for monitoring the at least one temperature-related system component parameter by detecting changes in the at least one temperature-related system component parameter.

31. The processing system according to claim 23, wherein the controller is configured for determining the cleaning status of the system component by comparing the at least one monitored temperature-related system component parameter to a threshold value.

32. The processing system according to claim 31, wherein the threshold value comprises a preselected system component temperature value.

33. The processing system according to claim 26, wherein the controller is configured for determining the cleaning status of the system component by comparing the monitored adjusted heating power, adjusted cooling power, or both, to the respective preselected value that is applied to the system component prior to exposing the system component to the cleaning gas.

34. The processing system according to claim 31, wherein the controller is configured for controlling the processing system by stopping the chamber cleaning process after the threshold value has been reached.

35. The processing system according to claim 23, wherein the controller is further configured for determining cleaning status by calculating an adjusted system component parameter by linking monitored values for two or more temperature-related system component parameters and comparing the adjusted system component parameter to an adjusted threshold value calculated by linking preselected values for the two or more temperature-related system component parameters.

36. The processing system according to claim 23, wherein the system component comprises a substrate holder, a showerhead, a shield, a baffle, a ring, an electrode, or a chamber wall.

37. The processing system according to claim 23, wherein the system component comprises a ceramic substrate holder containing at least one of Al₂O₃, AlN, SiC, BeO, or LaB₆, or a combination thereof.

38. The processing system according to claim 23, wherein the material deposit contains at least one of a silicon-containing deposit, a high-k deposit, a metal deposit, a metal oxide deposit, or a metal nitride deposit.

39. The processing system having a process chamber, comprising:
a system component having a material deposit thereon;
means for exposing the system component in the process chamber to a cleaning gas in an exothermic chamber cleaning process to remove the material deposit from the system component; and
processing means for:
monitoring at least one temperature-related system component parameter in the chamber cleaning process;
determining the cleaning status of the system component from the monitoring, and
controlling the processing system in response to the status.

40. The processing system according to claim 39, further comprising:
means for applying heating power to the system component.

41. The processing system according to claim 39, further comprising:
means for applying cooling power to the system component.
